(19) United States
(12) Patent Application Publication
(10) Pub. No.: US 2017/0161775 A1
(43) Pub. Date: Jun. 8, 2017

(54) MEDIATION SYSTEM, MEDIATION APPARATUS, MEDIATION METHOD, AND COMPUTER PROGRAM

(71) Applicant: Kabushiki Kaisha Toshiba, Tokyo (JP)

(72) Inventors: Yasuo OOYA, Setagaya Tokyo (JP); Shinichi KURIHARA, Yokohama Kanagawa (JP)

(21) Appl. No.: 15/441,061

(22) Filed: Feb. 23, 2017

Related U.S. Application Data
(63) Continuation of application No. PCT/JP2015/068344, filed on Jun. 25, 2015.

(30) Foreign Application Priority Data
Aug. 29, 2014 (JP) 2014-176527

(51) Int. Cl. G06Q 30/02

(52) U.S. Cl. CPC G06Q 30/0245

(57) ABSTRACT

A mediation system according to an embodiment includes a broadcasting device, a broadcast receiver, and a mediation apparatus. The broadcasting device transmits broadcast data including information related to a product or a service. The broadcast receiver receives the broadcast data. The mediation apparatus communicates with the broadcast receiver. The broadcast receiver includes a display unit, an input unit, and a communicator. The display unit displays information related to a product or a service included in received broadcast data. An input unit receives an input of an operation from a viewer who selects the product or the service according to display on the display unit. The communicator transmits selected information indicating a selection of a viewer to the mediation apparatus. The mediation apparatus includes a mediation unit. The mediation unit acquires information related to the viewer and transmits information related to a product and a service indicated by the selected information to the broadcast receiver.

### TECHNICAL FIELD

Embodiments of the present invention relates to a mediation system, a mediation apparatus, a mediation method, and a computer program.

### BACKGROUND ART

Conventionally, advertisements for products have been distributed through television broadcasting. On the other hand, with the spread of the Internet, consumers purchasing products from electronic commerce (EC) sites are increasing. For example, a consumer who has decided to purchase a product shown on a television broadcast first searches for a sales site of the product at a search site on the Internet. The consumer accesses the hit sales site and performs a purchase procedure. When a product is purchased in this manner, a sales company of the product cannot know whether the motivation of the consumer for the purchase was due to television broadcasting. For this reason, it is difficult for the sales company to acquire information representing an advertisement effect of the product due to broadcasting of an advertisement.

### SUMMARY

A mediation system according to an embodiment includes a broadcasting device, a broadcast receiver, and a mediation apparatus. The broadcasting device transmits broadcast data including information related to a product or a service. The broadcast receiver receives the broadcast data. The mediation apparatus communicates with the broadcast receiver. The broadcast receiver includes a display unit, an input unit, and a communicator. The display unit displays information related to the product or the service included in received broadcast data. An input unit receives an input of an operation by a viewer who selects the product or the service according to a display on the display unit. The communicator transmits selected information indicating a selection of a viewer to the mediation apparatus. The mediation apparatus includes a mediation unit. The mediation unit acquires information related to the viewer and transmits information related to a product and a service indicated by the selected information to the broadcast receiver.

### BRIEF DESCRIPTION OF DRAWINGS

FIG. 1 is a system configuration diagram which shows a system configuration of a broadcasting sales system according to a first embodiment.

FIG. 2 is a functional block diagram which shows a functional configuration of a mediation apparatus 4.

FIG. 3 is a diagram which shows a specific example of a sales information table 421.

FIG. 4 is a diagram which shows a specific example of a viewer information table 431.

FIG. 5 is a diagram which shows a specific example of a mediation information table 441.

FIG. 6 is a functional block diagram which shows a functional configuration of a broadcasting system 1.

FIG. 7 is a sequence diagram which shows a flow of mediation processing in the broadcasting sales system of the first embodiment.

FIG. 8 is a sequence diagram which shows a flow of the mediation processing in the broadcasting sales system of the first embodiment.

FIG. 9 is a system configuration diagram which shows a system configuration of a broadcasting sales system according to a second embodiment.

FIG. 10 is a functional block diagram which shows a functional configuration of a mediation apparatus 4a.

FIG. 11 is a diagram which shows a specific example of a sales company information table 481.

FIG. 12 is a sequence diagram which shows a flow of mediation processing in the broadcasting sales system of the second embodiment.

FIG. 13 is a sequence diagram which shows a flow of the mediation processing in the broadcasting sales system of the second embodiment.

### EMBODIMENTS

Hereinafter, a mediation system, a mediation apparatus, a mediation method, and a computer program will be described with reference to drawings.

### First Embodiment

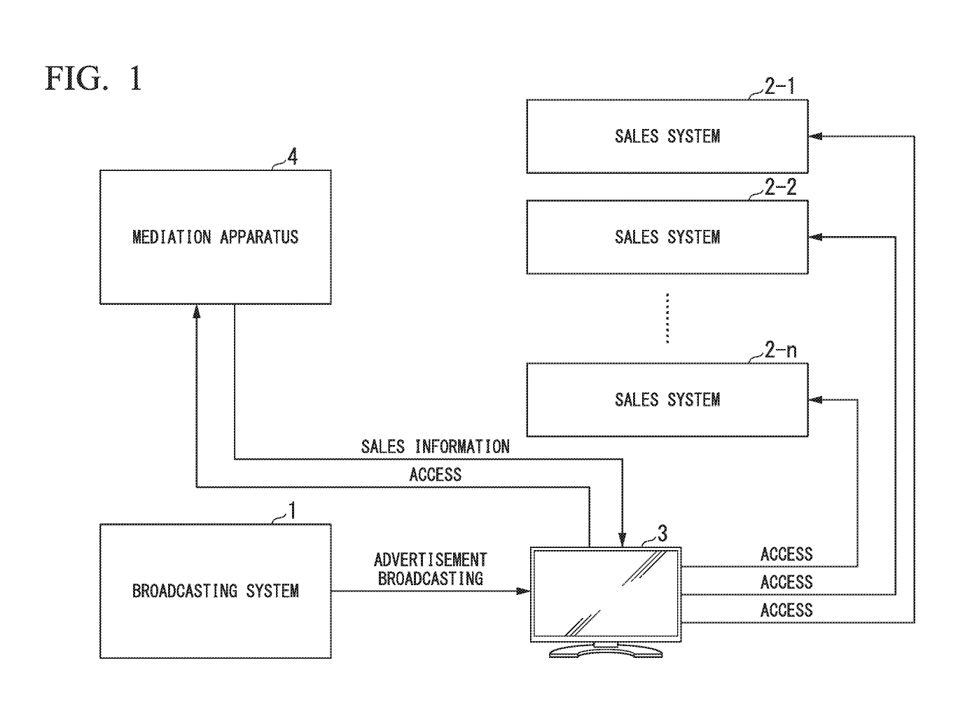

FIG. 1 is a system configuration diagram which shows a system configuration of a broadcasting sales system according to a first embodiment.

A broadcasting system 1 (broadcasting device) is a system that broadcasts television programs. In general, the broadcasting system 1 is operated by a broadcasting company. The broadcasting company makes a contract for advertisement broadcasting with an advertiser and broadcasts an advertisement based on the content of the contract. For example, the advertiser is a product developer such as a product maker or a service operator. The broadcasting company acquires information (hereinafter, referred to as “advertisement information”) necessary for broadcasting of an advertisement (hereinafter, referred to as “advertisement broadcasting”) from the advertiser and inputs the information in the broadcasting system 1. The broadcasting system 1 creates a schedule for broadcasting advertisement broadcasting on the basis of the advertisement information, and broadcasts advertisement broadcasting on the basis of the schedule. The broadcasting system 1 transmits radio waves combining broadcast video data and information related to a broadcast (hereinafter, referred to as “related information”). The related information is generated on the basis of the advertisement information. As a method of combining and broadcasting the video data and the related information, there are methods such as a data broadcasting method and a hybrid casting method. In a broadcasting sales system (mediation system) of the embodiment, the related information includes identification information of an advertisement product and access information for a viewer to access a mediation apparatus 4.

The sales systems 2-1 to 2-n are systems which configure an EC site for each sales company that sells a product via a communication line such as the Internet. N is an integer equal to or greater than 1 and represents the number of sales systems. In the following description, the sales systems 2-1 to 2-n are described as a sales system 2 when they are not particularly distinguished for simplicity of description. In addition, even if one sales company operates a plurality of sales systems 2 in some cases, for simplicity of description in the present embodiment, it is assumed that one sales company operates one sales system 2. In this case, n is the number of sales companies. In the following description, a sales company operating a sales system 2-n is described as a sales company n.

The sales systems 2-1 to 2-n receive orders of products via a communication line, and perform sales processing on ordered products. A sales company operating the sales system 2 may be an advertiser himself or herself or may be a business operator other than an advertiser. The sales company is assumed to be a business operator other than an advertiser in the present embodiment. For example, the sales company is a wholesale dealer who purchases products from an advertiser and secondarily sells the products.

The broadcast receiver 3 (terminal) is a device which receives radio waves of television broadcasting transmitted by the broadcasting system 1 and displays a broadcast video. For example, the broadcast receiver 3 is a device such as a television, a smart phone, a mobile phone, or the like. Moreover, the broadcast receiver 3 acquires related information included in the received radio waves, and performs a display of the related information or operation processing according to an operation or settings of a viewer.

In addition, the broadcast receiver 3 includes a communication interface such as a local area network (LAN), and communicates between the sales system 2 and the mediation apparatus 4. The broadcast receiver 3 accesses the mediation apparatus 4 on the basis of the access information included in the related information. The broadcast receiver 3 transmits the identification information related to an advertisement product included in the related information and authentication information to the mediation apparatus 4. The authentication information includes identification information related to a viewer and qualification information for using the mediation apparatus 4. The broadcast receiver 3 includes a storage configured using a storage device such as a magnetic hard disk device or a semiconductor storage device, and the authentication information is stored in the storage in advance. The authentication information may also be input to the broadcast receiver 3 by an operation of a viewer.

The mediation apparatus 4 is a device which mediates between viewing of advertisement broadcasting using the broadcast receiver 3 and sales of products by the sales system 2. The mediation apparatus 4 may be operated by a broadcasting company, an advertiser, or a sales company, and may also be operated by other business operators. In the present embodiment, it is assumed that the mediation apparatus 4 is operated by an advertiser. Sales information is registered in the mediation apparatus 4 by the advertiser in advance. The sales information is information which includes information related to a product (hereinafter, referred to as “product information”) and URL information indicating a URL of an EC site of a sales company selling a product. For example, the product information is information such as a product price, a product specification, a user review, a satisfaction level, or comments. The sales information is registered for each sales company.

The mediation apparatus 4 communicates with the broadcast receiver 3, and acquires identification information of an advertisement product from the broadcast receiver 3. The mediation apparatus 4 acquires product information of one or more sales companies on the basis of the acquired identification information of an advertisement product. The mediation apparatus 4 transmits the acquired product information to the broadcast receiver 3. The mediation apparatus 4 transmits URL information of a sales company corresponding to a piece of product information selected among the transmitted product information to the broadcasting receiving device 3. Sales information transmitted to the broadcast receiver 3 from the mediation apparatus 4 may be one or more pieces of information. A transmission time of a plurality of pieces of sales information may be selectable by an operation of a viewer.

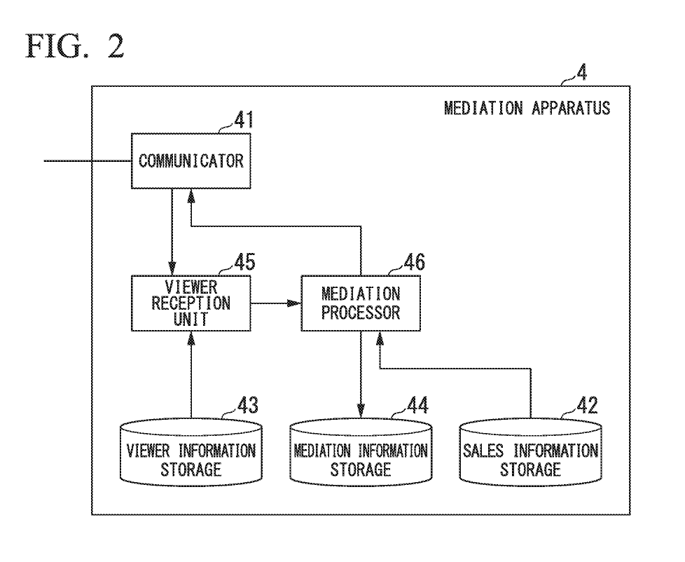

FIG. 2 is a functional block diagram which shows a functional configuration of the mediation apparatus 4.

The mediation apparatus 4 includes a central processing unit (CPU), a memory, an auxiliary storage device, and the like connected by a bus, and executes a mediation apparatus program. The mediation apparatus 4 functions as a device including a communicator 41, a sales information storage 42, a viewer information storage 43, a mediation information storage 44, a viewer reception unit 45, and a mediation processor 46. The sales information storage 42, the viewer information storage 43, and the mediation information storage 44 are configured using a storage device such as a magnetic hard disk device or a semiconductor storage device. All or a portion of respective functions of the mediation apparatus 4 may be realized by hardware such as an application specific integrated circuit (ASIC), a programmable logic device (PLD), or a field programmable gate array (FPGA). The mediation apparatus program may also be recorded in a computer readable recording medium. The computer readable recording medium is a storage device, for example, a portable medium such as a flexible disk, a magneto-optical disc, a ROM, a CD-ROM, and a flash memory, or a hard disk and the like embedded in a computer system. The mediation apparatus program may be transmitted via an electrical communication line.

The communicator 41 is configured using a communication interface such as a local area network (LAN). The communicator 41 controls communication between the communicator and the broadcast receiver 3.

The sales information storage 42 stores a sales information table 421 holding sales information.

The viewer information storage 43 stores a viewer information table 431 that holds viewer information. The viewer information is information related to a viewer using the mediation apparatus 4. The mediation information storage 44 stores a mediation information table 441 that holds mediation information. The mediation information is information related to mediation of product purchases performed with respect to a viewer.

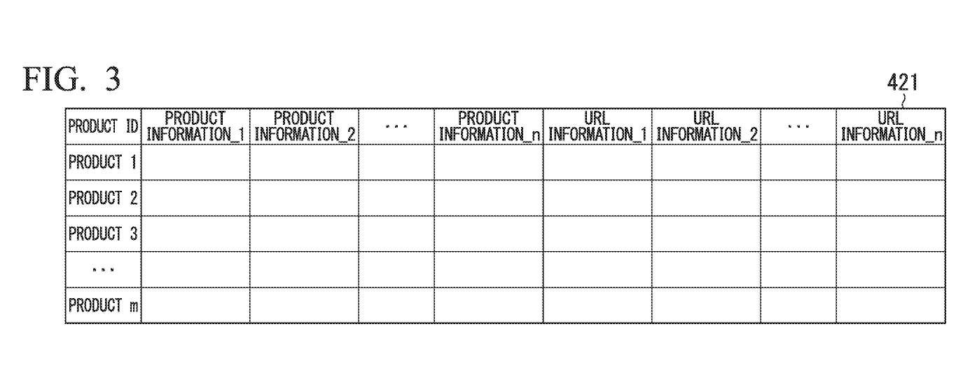

FIG. 3 is a diagram which shows a specific example of the sales information table 421.

The sales information table 421 includes a sales information record for each product ID. The sales information record includes a product ID, and respective values of product information_1 to n and URL information_1 to n. The product ID is identification information of an advertisement product. In FIG. 3, m product IDs of “product 1” to “product m” (m is an integer equal to or greater than 1) are shown. The product information_1 to n represent sales information in each sales company of products indicated by the product ID. Product information_1 represents sales information of a sales company 1. Product information_2 is sales information of a sales company 2. In the same manner, product information_n is sales information of a sales company n. The URL information_1 to n is URL information of an EC site of each sales company. URL information_1 is URL information of the sales company 1. URL information_2 is URL information of the sales company 2. URL information_n is URL information of the sales company n. The sales information record is registered or deleted in the sales information table 421 in advance by an advertiser.

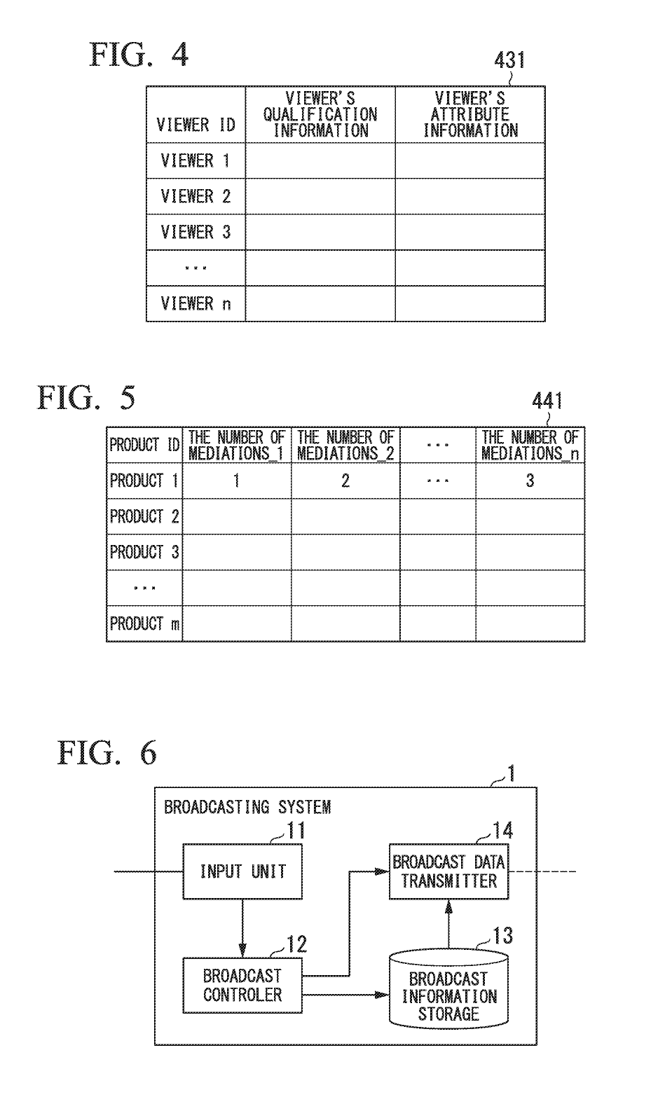

FIG. 4 is a diagram which shows a specific example of the viewer information table 431.

The viewer information table 431 has a viewer information record for each viewer ID. The viewer information record has a viewer ID, viewer qualification information, and viewer attribute information. The viewer ID is identification information of a viewer. In FIG. 4, n (n is an integer equal to or greater than 1) viewer IDs of “viewer 1” to “viewer n” are shown. The viewer qualification information is information necessary for authentication of a viewer using the mediation apparatus 4. For example, the viewer qualification information is a password set for each viewer. The viewer attribute information is information indicating an attribute of a viewer. The viewer attribute information is information such as a name, an age, an address, a telephone number, and an email address. The viewer information record is registered in the viewer information table 431 in advance by an administrator of the mediation apparatus 4.

FIG. 5 is a diagram which shows a specific example of the mediation information table 441.

The mediation information table 441 has a mediation information record for each product ID. The mediation information record has the product ID and respective values of the number of mediations_1 to n. The product ID is the same as the product ID registered in the sales information table 421. The number of mediations_1 to n represent the number of times the mediation apparatus 4 has mediated for a product indicated by the product ID. The number of mediations_1 is the number of times of mediation for the sales company 1. The number of mediations_2 is the number of mediations for the sales company 2. In the same manner, the number of mediations_n is the number of mediations for the sales company n. The mediation information record is registered in the mediation information table 441 by the mediation processor 46.

The procedure returns to FIG. 2.

The viewer reception unit 45 receives a viewer's access to advertisement broadcasting. At this time, the viewer reception unit 45 acquires the identification information of an advertisement product and the authentication information from the broadcast receiver 3. The viewer reception unit 45 authenticates a viewer who has accessed its own device on the basis of the acquired authentication information and the viewer information registered in the viewer information table 431. After viewer authentication, the viewer reception unit 45 outputs the acquired identification information of an advertisement product to the mediation processor 46. When the viewer reception unit 45 fails to authenticate a viewer or receives access from a viewer who is not registered, the viewer reception unit may be configured to perform preset processing such as urging the viewer to register.

The mediation processor 46 (mediation unit) performs mediation processing on the authenticated viewer. Specifically, the mediation processor 46 acquires the identification information of an advertisement product from the viewer reception unit 45.

The mediation processor 46 acquires sales information of a product indicated by the identification information of an advertisement product. The mediation processor 46 transmits the acquired sales information to the broadcast receiver 3 of the authenticated viewer. In addition, the mediation processor 46 acquires selected information which indicates sales information selected by a viewer from the broadcast receiver 3. The mediation processor 46 transmits URL information corresponding to the sales information indicated by the selected information to the broadcast receiver 3. Then, the mediation processor 46 registers mediation information in the mediation information table 441 after executing the mediation processing.

FIG. 6 is a functional block diagram which shows a functional configuration of the broadcasting system 1.

The broadcasting system 1 includes an input unit 11, a broadcast controller 12, a broadcast information storage 13, and a broadcast data transmitter 14.

The input unit 11 inputs advertisement information in its own device. The advertisement information includes information such as a category of an advertisement or a desired date of broadcasting, or related information. The input unit 11 outputs the advertisement information to the broadcast controller 12.

The broadcast controller 12 acquires the advertisement information from the input unit 11. The broadcast controller 12 creates a schedule for broadcasting advertisement broadcasting on the basis of the advertisement information. The broadcast controller 12 saves the created broadcast schedule in the broadcast information storage 13.

The input unit 11, the broadcast controller 12, the broadcast information storage 13, and the broadcast data transmitter 14 may be realized using a conventional broadcasting system or may be newly constructed.

The broadcast information storage 13 is configured using a storage device such as a magnetic hard disk device or a semiconductor storage device. The broadcast information storage 13 stores broadcast information. The broadcast information is information including the broadcast schedule created by the broadcast controller 12, the broadcast video data, the related information, and the like.

The broadcast data transmitter 14 acquires broadcast information from the broadcast information storage 13. The broadcast data transmitter 14 generates broadcast data which is data for broadcasting from the video data and the related information included in the broadcast information. The broadcast data transmitter 14 converts the broadcast data into radio waves for broadcasting, and transmits the broadcast data according to the broadcast schedule included in the broadcast information.

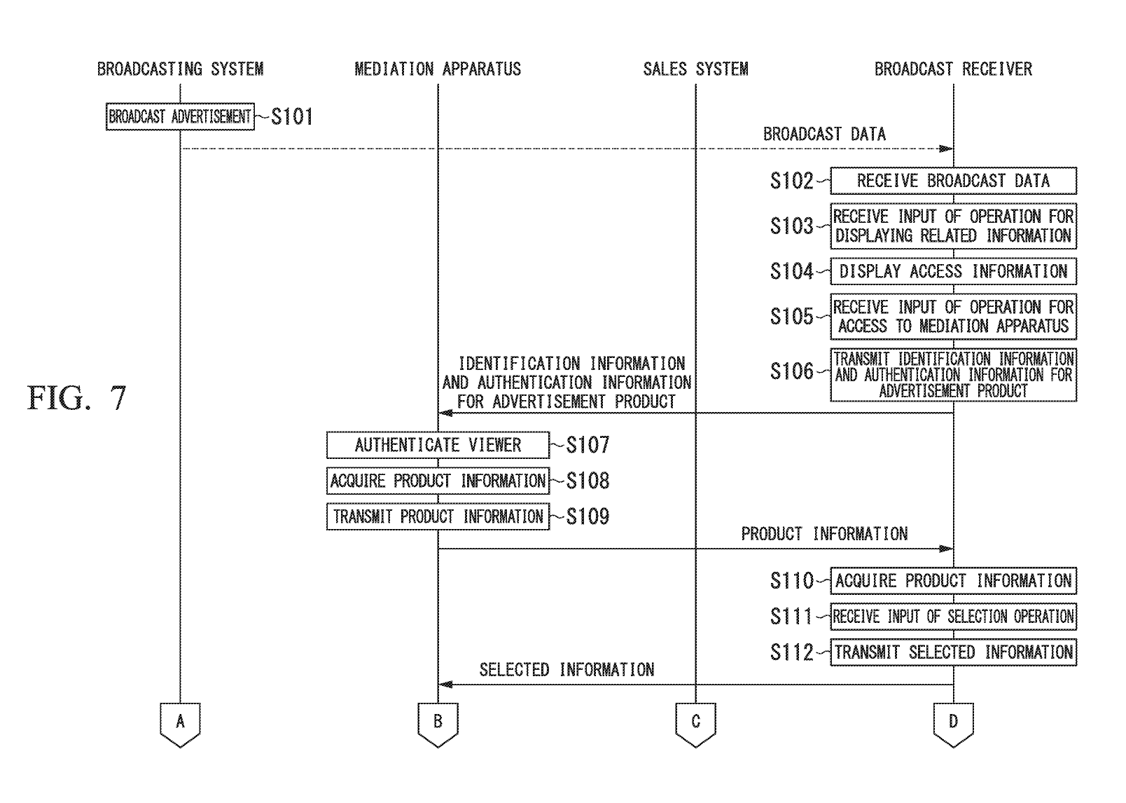

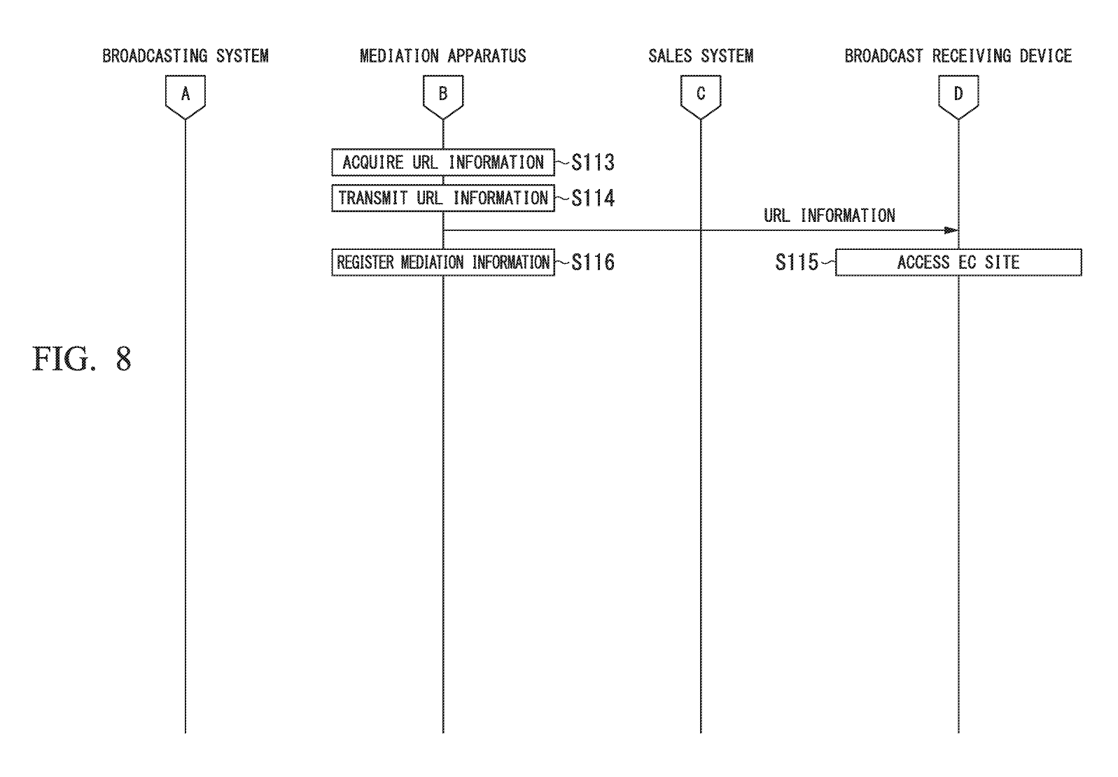

FIGS. 7 and 8 are sequence diagrams which show a flow of mediation processing in the broadcasting sales system of the first embodiment.

First, the broadcasting system 1 transmits the broadcast data and broadcasts an advertisement (step S101).

The broadcast receiver 3 receives the transmitted broadcast data (step S102). The broadcast receiver 3 acquires the video data and the related information from the received broadcast data. The broadcast receiver 3 displays the acquired video data. In addition, the broadcast receiver 3 saves the acquired related information in the storage.

Here, a viewer of advertisement broadcasting indicates the related information to the broadcast receiver 3 to purchase an advertisement product. The broadcast receiver 3 receives an input of an operation to display the related information (step S103). The broadcast receiver 3 displays the access information included in the related information (step S104). The viewer of advertisement broadcasting performs an operation to select the access information and access the mediation apparatus 4. The broadcast receiver 3 receives an input of an operation for access to the mediation apparatus 4 (step S105). The broadcast receiver 3 acquires the identification information of an advertisement product from the related information. The broadcast receiver 3 acquires the authentication information from the storage. The broadcast receiver 3 transmits the identification information and the authentication information for an advertisement product to the mediation apparatus 4 (step S106).

The viewer reception unit 45 of the mediation apparatus 4 refers to the viewer information table 431 and selects a viewer record having the identification information of a viewer indicated by the authentication information in a value of the viewer ID. The viewer reception unit 45 acquires a value of viewer qualification information from the selected viewer record. The viewer reception unit 45 authenticates the viewer as a legitimate viewer when the information indicated by the authentication information is the same as the acquired viewer qualification information (step S107). If the viewer is authenticated, the viewer reception unit 45 outputs the identification information of an advertisement product to the mediation processor 46.

The mediation processor 46 acquires the identification information of an advertisement product from the viewer reception unit 45. The mediation processor 46 refers to the sales information table 421 and selects a sales information record having the identification information related to an advertisement product in a value of the product ID. The mediation processor 46 acquires the product information_1 to n from the selected sales information record (step S108). The mediation processor 46 transmits the acquired product information_1 to n to the broadcast receiver 3 of the viewer (step S109).

The broadcast receiver 3 acquires the product information_1 to n from the mediation processor 46. The broadcast receiver 3 displays the acquired product information_1 (step S110). Here, the viewer performs an operation to select one piece of product information from the displayed product information_1 to n. The broadcast receiver 3 receives an input of a selection operation from the viewer (step S111). The broadcast receiver 3 transmits selected information indicating the selected product information to the mediation apparatus 4 (step S112).

The mediation processor 46 of the mediation apparatus 4 acquires the selected information from the broadcast receiver 3. The mediation processor 46 acquires a value of URL information corresponding to the product information indicated by the selected information from the sales information record selected in step S108 (step S113). For example, when the selected information indicates the product information_{'}1, the mediation processor 46 acquires a value of the URL information_1. In addition, when the selected information indicates the product information_2, the mediation processor 46 acquires a value of the URL information_2. In the same manner, when the selected information indicates the product information_n, the mediation processor 46 acquires a value of the URL information_n. The mediation processor 46 transmits the acquired URL information to the broadcast receiver 3 (step S114).

The broadcast receiver 3 acquires the URL information from the mediation processor 46. The broadcast receiver 3 accesses an EC site indicated by the URL information (step S115). The viewer performs a purchasing procedure from the EC site which is an access destination. The mediation processor 46 of the mediation apparatus 4 registers mediation information in the mediation information table 441 after transmitting the URL information (step S116). Specifically, the mediation processor 46 refers to the mediation information table 441 and selects a mediation information record having identification information related to the product which has been mediated in the value of the product ID. The mediation processor 46 acquires a value of the number of mediations corresponding to a sales company to be mediated from the selected mediation information record. For example, the mediated product is the product1 in the example of FIG. 5 and the sales company to be mediated is the sales company2, and the mediation processor 46 acquires a value of the number of mediations_2 from the selected mediation information record. That is, “2” is acquired as the number of mediations. The mediation processor 46 adds 1 to the acquired the number of mediations to reflect the current mediation in the number of mediations. The mediation processor 46 updates the mediation information record with a value in which the current mediation is reflected. For example, in the example described above, a value of the number of mediations_2 is updated to “3” in the mediation information record of the product1.

In the broadcasting sales system of the first embodiment configured in this manner, the mediation apparatus 4 transmits product information of each sales company to the broadcast receiver 3 based on the identification information of an advertisement product acquired from advertisement broadcasting. Then, the mediation apparatus 4 transmits URL information of a sales company selected by a viewer to the broadcast receiver 3. The mediation apparatus 4 can acquire the number of viewers who have watched advertisement broadcasting and purchased a product by performing the mediation processing. Therefore, a user of the mediation apparatus 4 can more easily acquire information representing an advertisement effect of a product by advertisement broadcasting

In addition, the broadcast receiver 3 acquires URL information of a sales company from which an advertisement product can be purchased based on the received broadcast data. Therefore, a viewer does not need to search for a sales company of an advertisement product and can more simply purchase the advertisement product.

### Second Embodiment

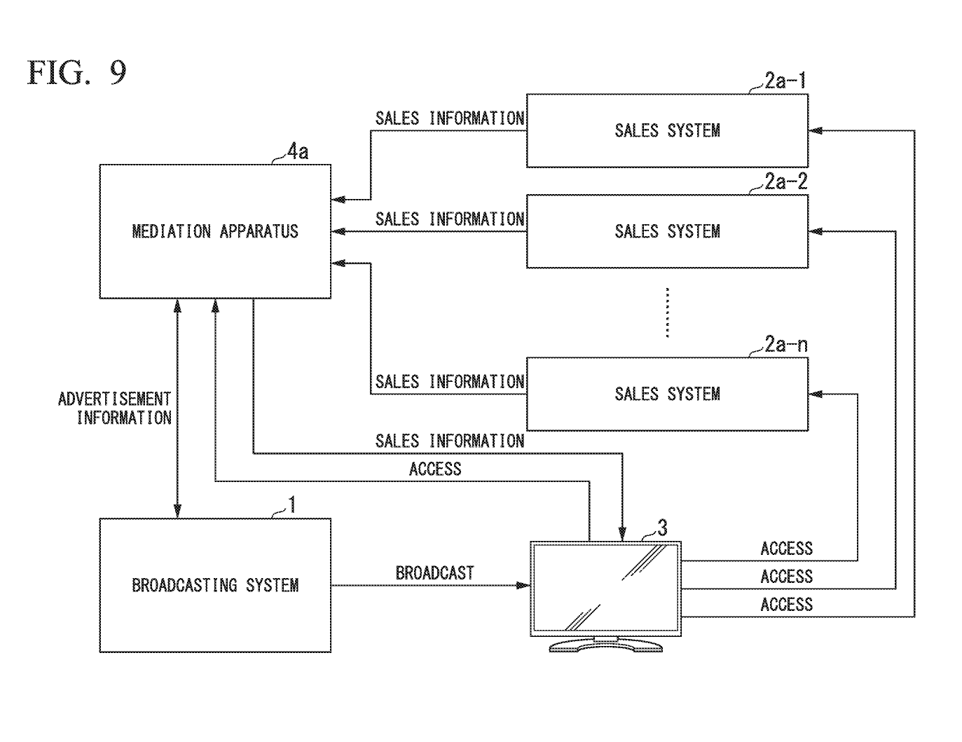

FIG. 9 is a system configuration diagram which shows a system configuration of a broadcasting sales system according to a second embodiment.

The broadcasting sales system according to the second embodiment is different from the broadcasting sales system of the first embodiment in that sales systems 2a-1 to 2a-n are provided instead of the sales systems 2-1 to 2-n, and a mediation apparatus 4a is provided instead of the mediation apparatus 4. The sales systems 2a-1 to 2a-n communicate with the mediation apparatus 4a, and transmits sales information of a product sold in their own systems to the mediation apparatus 4a. The mediation apparatus 4a acquires product information of an advertisement product from the sales systems 2a-1 to 2a-n. The mediation apparatus 4a generates advertisement information on the basis of the product information and transmits the advertisement information to the broadcasting system 1.

While sales information is registered in the mediation apparatus 4 by an advertiser in advance in the broadcasting sales system of the first embodiment, in the broadcasting sales system of the second embodiment, sales information is registered in the mediation apparatus 4 by each sales system 2a. In addition, while advertisement information is provided to a broadcasting company from an advertiser and is input to the broadcasting system 1 by the broadcasting company in the broadcasting sales system of the first embodiment, advertisement information is generated by the mediation apparatus 4a on the basis of the sales information registered in the mediation apparatus 4a and is input to the broadcasting system 1 in the broadcasting sales system of the second embodiment.

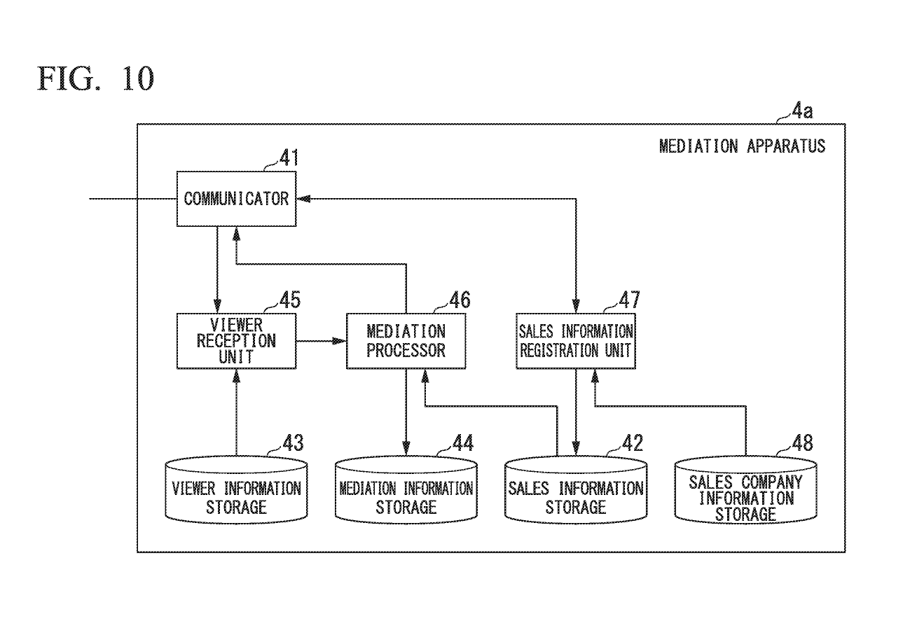

FIG. 10 is a functional block diagram which shows a functional configuration of the mediation apparatus 4a.

The mediation apparatus 4a is different from the mediation apparatus 4 in which the mediation apparatus 4a further includes a sales information registration unit 47 and a sales company information storage 48.

The sales information registration unit 47 receives registration of sales information by each sales system 2a. At the time of registration of sales information, sales company authentication information and sales information of each sales company are transmitted to the mediation apparatus 4a. The sales company authentication information includes identification information of a sales company and qualification information for registering the sales information in the mediation apparatus 4a. The sales information registration unit 47 authenticates a sales company on the basis of the sales company authentication information transmitted from each sales system 2a, and registers sales information of the authenticated sales company in the sales information table 421. The sales information registration unit 47 generates advertisement information on the basis of the acquired sales information. The sales information registration unit 47 transmits the generated advertisement information to the broadcasting system 1.

The sales company information storage 48 stores the sales company information table 481 in which sales company information is saved. The sales company information is information related to a sales company operating each sales system 2a.

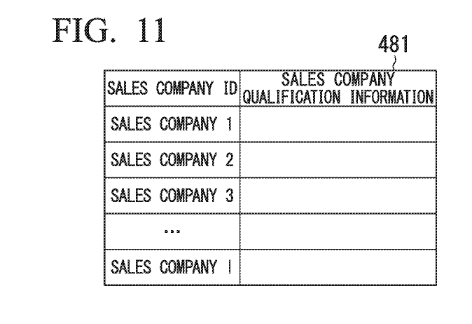

FIG. 11 is a diagram which shows a specific example of the sales company information table 481.

The sales company information table 481 has a sales company information record for each sales company ID. The sales company information record has a sales company ID and each value of sales company qualification information. The sales company ID is identification information of a sales company. FIG. 11 shows l (l is an integer equal to or greater than 1) sales company IDs of “sales company 1” to “sales company 1”. The sales company qualification information is information necessary for authentication of a sales company which is registered in the mediation apparatus 4a. For example, the sales company qualification information is a password set for each sales company. The sales company information record is registered in the sales company information table 481 in advance by an administrator of the mediation apparatus 4a.

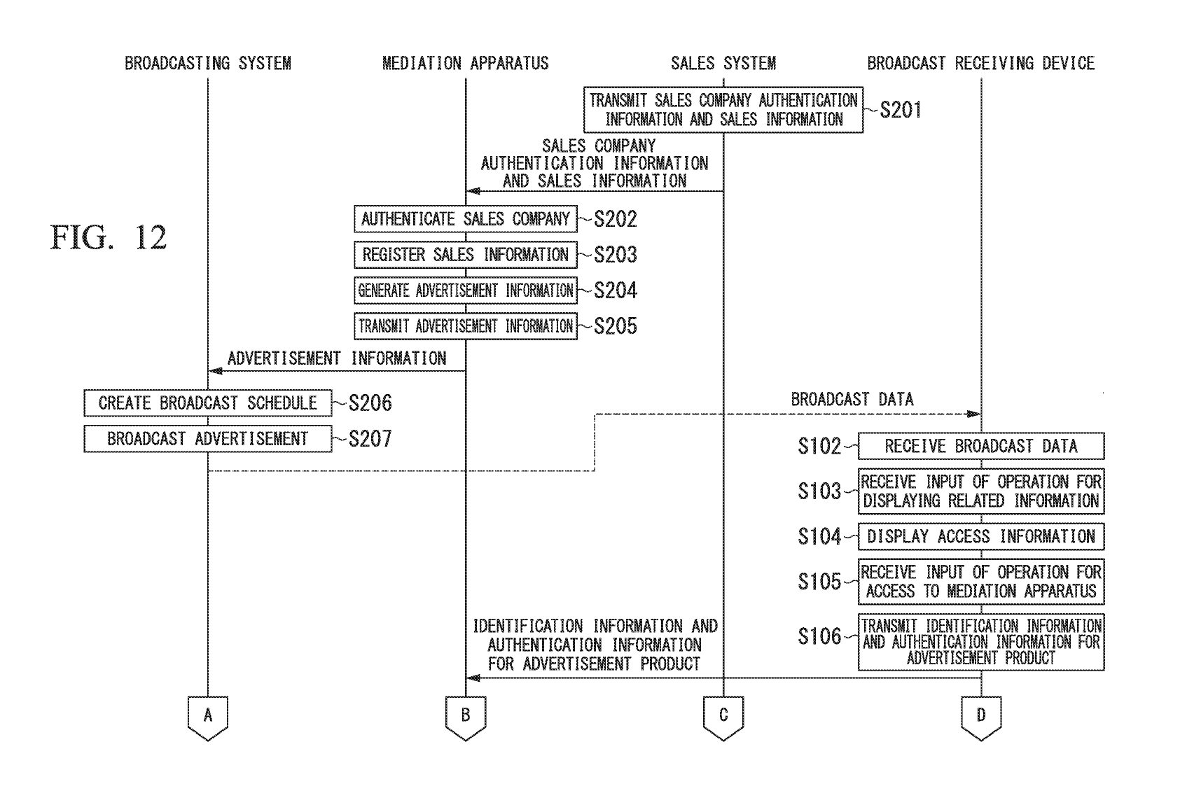

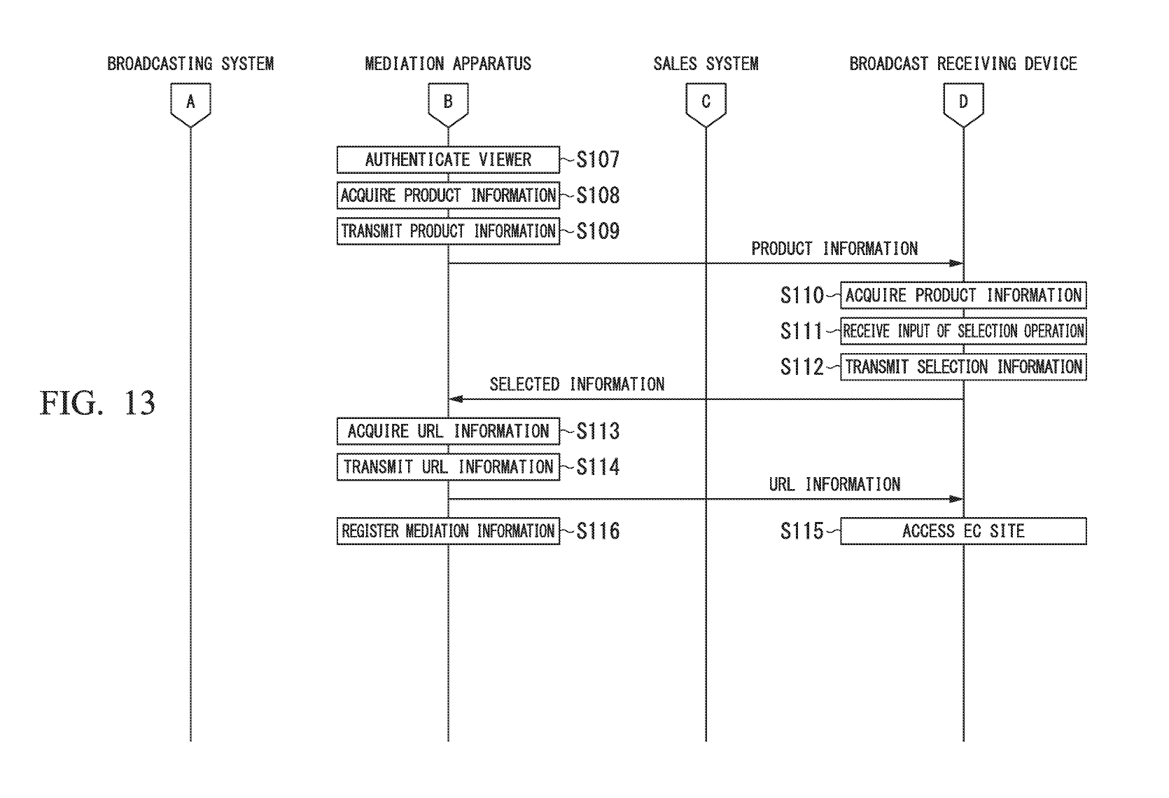

FIGS. 12 and 13 are sequence diagrams which show a flow of mediation processing in the broadcasting sales system of the second embodiment.

First, the sales system 2a transmits sales information to the mediation apparatus 4a for registration of the sales information (step S201). At this time, each sales system 2a transmits the sales company qualification information and the sales information. The sales information registration unit 47 of the mediation apparatus 4a acquires the sales company authentication information and the sales information from the sales system 2a. The sales information registration unit 47 refers to the sales company information table 481 and selects a sales company information record having the identification information of a sales company indicated by the sales company authentication information in a value of the sales company ID. The sales information registration unit 47 authenticates the sales company is a legitimate sales company when qualification information indicated by the sales company authentication information is the same as the acquired sales company qualification information (step S202). If the sales company is authenticated, the sales information registration unit 47 registers the sales information in the sales information table 421 (step S203).

The sales information registration unit 47 generates advertisement information on the basis of the registered sales information (step S204). The sales information registration unit 47 transmits the generated advertisement information to the broadcasting system 1 (step S205). The input unit 11 of the broadcasting system 1 acquires the advertisement information from the mediation apparatus 4a and outputs the advertisement information to the broadcast controller unit 12. The broadcast controller 12 acquires the advertisement information from the input unit 11. The broadcast controller 12 creates a schedule for broadcasting advertisement broadcasting on the basis of the advertisement information (step S206). The broadcast controller 12 saves the created broadcast schedule in the broadcast information storage 13. The broadcast data transmitter 14 acquires the broadcast information from the broadcast information storage 13. The broadcast data transmitter 14 generates broadcast data which is data for broadcasting from the video data and the related information included in the broadcast information. The broadcast data transmitter 14 is converted into radio waves for broadcasting. The broadcast data transmitter 14 transmits the radio waves into which the broadcast data is converted according to the broadcast schedule included in the broadcast information, and broadcasts an advertisement (step S207). A flow of subsequent processing is the same as in FIGS. 7 and 8.

In the broadcasting sales system of the second embodiment configured in this manner, the mediation apparatus 4a receives a registration of sales information by the sales system 2a. The mediation apparatus 4a generates advertisement information on the basis of the sales information registered by the sales system 2a. The mediation apparatus 4a transmits the generated advertisement information to the broadcasting system 1. The mediation apparatus 4a has the above functions, and thereby an administrator of the mediation apparatus 4a can more easily operate the mediation apparatus 4a.

According to at least one embodiment, it is possible to more easily acquire information representing an advertisement effect of a product by advertisement broadcasting by having a mediation processor which transmits product information and URL information to the broadcasting receiving device of a viewer on the basis of the identification information of an advertisement product acquired from the advertisement broadcasting.

Next, a modified example of the broadcasting sales system of embodiments will be described.

When a plurality of pieces of advertisement broadcasting for one product are broadcast, the mediation apparatus 4 may also acquire mediation information related to one product for each advertisement. In this case, a sales information record of the sales information table 421 further includes a value of an advertisement ID. In the same manner, a mediation information record of the mediation information table 441 also further includes the value of an advertisement ID. The advertisement ID is identification information of an advertisement. A broadcasting company inputs identification information of an advertisement instead of the identification information of an advertisement product in the broadcasting system 1 included in the related information. The broadcast receiver 3 acquires the identification information of an advertisement from the broadcast data. The broadcast receiver 3, in step 106, transmits the identification information of an advertisement instead of the identification information of an advertisement product to the mediation apparatus 4. The mediation apparatus 4, in steps 108 and 116, can acquire mediation information for each advertisement by performing processing using the identification information of an advertisement instead of the identification information of an advertisement product. In this manner, the mediation information is acquired, and thereby an advertiser can acquire information representing an advertisement effect for each advertisement. This modified example may also be applied to the mediation apparatus 4a.

The mediation processor 46 of the mediation apparatus 4 may also transmit viewer attribute information to the sales system 2 in the mediation processing. The viewer attribute information is transmitted, and thereby the sales system 2 can use the transmitted viewer attribute information to improve a service in product sales. For example, when information of each sales system 2 (for example, a user ID and a password) necessary for using the sales system 2 is included the viewer attribute information, the sales system 2 may be configured to automatically authenticate a viewer who performing access. This modified example may also be applied to the mediation apparatus 4a.

The mediation apparatus 4 may also acquire mediation information based on information other than the identification information of an advertisement product acquired from the advertisement broadcasting. For example, the mediation apparatus 4 acquires a broadcast schedule from the broadcasting system 1. Then, the mediation apparatus 4 stores a broadcast schedule of advertisement broadcasting in correlation with an advertisement product. The mediation apparatus 4 specifies an advertisement product on the basis of a date when the broadcast receiver 3 accesses its own device and a broadcast schedule. The mediation apparatus 4 updates the mediation information table 441 for the specified advertisement product. In addition, for example, when advertisement broadcasting is broadcast by a plurality of channels, the broadcast receiver 3 may also transmit channel information indicating a channel by which advertisement broadcasting watched by a viewer is broadcast to the mediation apparatus 4. The channel information is transmitted, and thereby the mediation apparatus 4 can acquire mediation information for each channel. This modified example may be applied to the mediation apparatus 4a.

A broadcasting sales system which mediates access information related to access to a sales site of a product to a viewer of advertisement broadcasting has been described above. However, a broadcast watched by a viewer is not limited to advertisement broadcasting. For example, the broadcast watched by a viewer may also be a broadcast such as a drama program or a variety program. In addition, information mediated by the broadcasting sales system is not limited to the access information. For example, the information mediated by the broadcasting sales system may be information related to a product or information related to a manufacturer or a seller of a product.

Although several embodiments of the present invention have been described, these embodiments are presented as an example, and the scope of the present invention is not intended to be limited. These embodiments can be implemented in various other embodiments, and various omissions, replacements, and changes can be performed in a scope not departing from a gist of the invention. These embodiments and this modified example are included in the scope and the gist of the invention and are also included in a scope equivalent to the invention described in the scope of the claims.

What is claimed is:

1. A mediation system comprising:
a broadcasting device configured to transmit broadcast data including information related to a product or a service;
a broadcast receiver configured to receive the broadcast data; and
a mediation apparatus configured to communicate with the broadcast receiver,
wherein the broadcast receiver comprises:
a display unit configured to display information related to the product or the service included in received broadcast data;
an input unit configured to receive an input of an operation by a viewer who selects the product or the service according to display on the display unit; and
a communicator configured to transmit selected information indicating a selection of the viewer to the mediation apparatus, and
wherein the mediation apparatus comprises:
a mediation unit configured to acquire information related to the viewer and transmit information related to a product and a service indicated by the selected information to the broadcast receiver.

2. A mediation apparatus comprising:
a communicator configured to receive selected information of a viewer who selects a product or a service according to display of information related to the product or the service included in received broadcast data; and
a mediation unit configured to acquire information related to the viewer and transmit information related to a product or a service indicated by the selected information to the broadcast receiver.

3. The mediation apparatus according to claim 2,
wherein the mediation unit acquires information related to the viewer for each of the products or the services.

4. The mediation apparatus according to claim 2,
wherein the mediation unit transmits information related to a seller of the product or a provider of the service as the information related to a product or a service indicated by the selected information.

5. The mediation apparatus according to claim 2,
wherein the mediation unit acquires information related to a viewer's access to his or her own device as information related to the viewer.

6. The mediation apparatus according to claim 2,
wherein the broadcast data comprises identification information of a broadcasting station, and
the mediation unit acquires information related to the viewer for each piece of the identification information of a broadcasting station.

7. A mediation method comprising:
receiving selected information of a viewer who selects a product or a service according to display of information related to the product or the service included in received broadcast data; and
acquiring information related to the viewer; and
transmitting information related to a product or a service indicated by the selected information to the broadcast receiver.

8. The mediation method according to claim 7,
wherein the information related to a viewer is acquired for each of the products or the services in acquiring the information related to the viewer.

9. The mediation method according to claim 7,
wherein information related to a seller of the product or a provider of the service is transmitted as information related to a product or a service indicated by the selected information in transmitting the information related to the products or the services.

10. The mediation method according to claim 7,
wherein information related to a viewer's access to his or her own device is acquired as the information related to a viewer in acquiring the information related to the viewer.

11. The mediation method according to claim 7,
wherein the broadcast data comprises identification information related to a broadcasting station, and
the information related to a viewer is acquired for each piece of the identification information of a broadcasting station in acquiring the information related to the viewer.

12. A non-transitory computer readable storage medium which stores a computer program, when executed by a computer, to cause the computer to perform a method comprising:
receiving selected information related to on a viewer who selects a product or a service according to display of information related to the product or the service included in received broadcast data; and
acquiring the information related to a viewer; and
transmitting information related to a product or a service indicated by the selected information.
